(19) United States
(12) Patent Application Publication
(10) Pub. No.: US 2026/0181410 A1
(43) Pub. Date: Jun. 25, 2026

(54) COMMUNICATION METHODS, APPARATUS, DEVICE, AND STORAGE MEDIUM

(71) Applicant: BEIJING XIAOMI MOBILE SOFTWARE CO., LTD., Beijing (CN)

(72) Inventor: Mingju LI, Beijing (CN)

(73) Assignee: BEIJING XIAOMI MOBILE SOFTWARE CO., LTD., Beijing (CN)

(21) Appl. No.: 19/125,544

(22) PCT Filed: Nov. 4, 2022
(86) PCT No.: PCT/CN2022/130067

§ 371 Date: Apr. 29, 2025

(51) Int. Cl. H04W 16/28; H04W 24/10

(52) U.S. Cl. CPC H04W 16/28; H04W 24/10

(57) ABSTRACT

The present disclosure relates to communication methods, an apparatus, a device and a storage medium. A method comprises: determining beam report information, the beam report information comprising beam quality information and beam accuracy information, and the beam accuracy information being used for indicating the accuracy of beam quality information; and sending to a network device the beam report information. The beam accuracy information, which is carried in the beam report information sent to the network device, may indicate whether the beam quality of a corresponding beam is accurate, thereby improving the accuracy of prediction on beams by a beam prediction model.

### CROSS-REFERENCE TO RELATED APPLICATIONS

The application is a U.S. National Stage of International Application No. PCT/CN2022/130067 filed on Nov. 4, 2022, the entire content of which is incorporated herein by reference.

### TECHNICAL FIELD

The present disclosure relates to the technical field of communication, and in particular, to a communication method and apparatus, a device and a storage medium.

### BACKGROUND

In the new radio (NR), especially when the communication frequency band is in the frequency range 2, it is necessary to use beam-based transmission and reception to ensure coverage range due to the rapid attenuation of high-frequency channels.

In some beam management processes, the network device configures a reference signal resource set for beam measurement. The terminal measures the reference signal resources in the reference signal resource set. The terminal may report identifiers of some relatively strong reference signal resources among them, along with the corresponding layer 1 reference signal received powers (L1-RSRP) and/or layer 1 signal to interference plus noise ratios (L1-SINR) to the network device.

In the current traditional manner, the reference signal resource set configured by the network device includes X reference signals, and each reference signal corresponds to a different transmitting beam of the network device. For each reference signal, the terminal needs to use all receiving beams to measure the reference signal. Therefore, the number of beam pairs that the terminal needs to measure is M*N. M represents the number of transmitting beams of the network device, and N is the number of receiving beams of the terminal.

### SUMMARY

According to a first aspect of the embodiments of the present disclosure, a communication method is provided, which is applied to a terminal, and the method includes: determining beam report information, where the beam report information includes beam quality information and beam accuracy information, and the beam accuracy information is used for indicating a degree of accuracy of the beam quality information; and sending the beam report information to a network device.

According to a second aspect of the embodiment of the present disclosure, a communication method is provided, which is applied to a network device, and the method includes: receiving beam report information sent by a terminal; where the beam report information includes beam quality information and beam accuracy information, and the beam accuracy information is used for indicating a degree of accuracy of the beam quality information.

According to a third aspect of the embodiments of the present disclosure, a communication apparatus is provided, which is configured in a terminal and includes: a determination module, configured to determine beam report information, where the beam report information includes beam quality information and beam accuracy information, and the beam accuracy information is used for indicating a degree of accuracy of the beam quality information; and a sending module, configured to send the beam report information to a network device.

According to a fourth aspect of the embodiments of the present disclosure, a communication apparatus is provided, which is configured in a network device and includes: a receiving module, configured to receive beam report information sent by a terminal, where the beam report information includes beam quality information and beam accuracy information, and the beam accuracy information is used for indicating a degree of accuracy of the beam quality information.

According to a fifth aspect of the embodiments of the present disclosure, a communication device is provided, including: a processor; and a memory for storing processor-executable instructions; where the processor is configured to execute any one of the methods in the first aspect.

According to a sixth aspect of the embodiments of the present disclosure, a communication device is provided, including: a processor; and a memory for storing processor-executable instructions; where the processor is configured to execute any one of the methods in the second aspect.

According to a seventh aspect of the embodiments of the present disclosure, a non-transitory computer-readable storage medium is provided. When instructions in the storage medium are executed by a processor of a terminal, the terminal is enabled to execute any one of the methods in the first aspect.

According to an eighth aspect of the embodiments of the present disclosure, a non-transitory computer-readable storage medium is provided. When instructions in the storage medium are executed by a processor of a network device, the network device is enabled to execute any one of the methods in the second aspect.

It is to be understood that the foregoing general description and the following detailed description are exemplary and explanatory only, and do not limit the present disclosure.

### BRIEF DESCRIPTION OF THE DRAWINGS

The accompanying drawings herein, which are incorporated in and constitute a part of the specification, illustrate embodiments consistent with the present disclosure and are used in conjunction with the specification to explain principles of the present disclosure.

FIG. 1 is a schematic diagram of a wireless communication system shown according to an exemplary embodiment.

FIG. 2 is a flow chart of a communication method shown according to an exemplary embodiment.

FIG. 3 is a flow chart of another communication method shown according to an exemplary embodiment.

FIG. 4 is a schematic diagram of a communication apparatus shown according to an exemplary embodiment.

FIG. 5 is a schematic diagram of another communication apparatus shown according to an exemplary embodiment.

FIG. 6 is a schematic diagram of a communication device shown according to an exemplary embodiment.

FIG. 7 is a schematic diagram of another communication device shown according to an exemplary embodiment.

### DETAILED DESCRIPTION

Exemplary embodiments will be described in detail herein, examples of which are represented in the accompanying drawings. When the following description relates to the drawings, the same numerals in different accompanying drawings represent the same or similar elements unless otherwise indicated. The implementations described in the following exemplary embodiments do not represent all implementations consistent with the embodiments of the present disclosure.

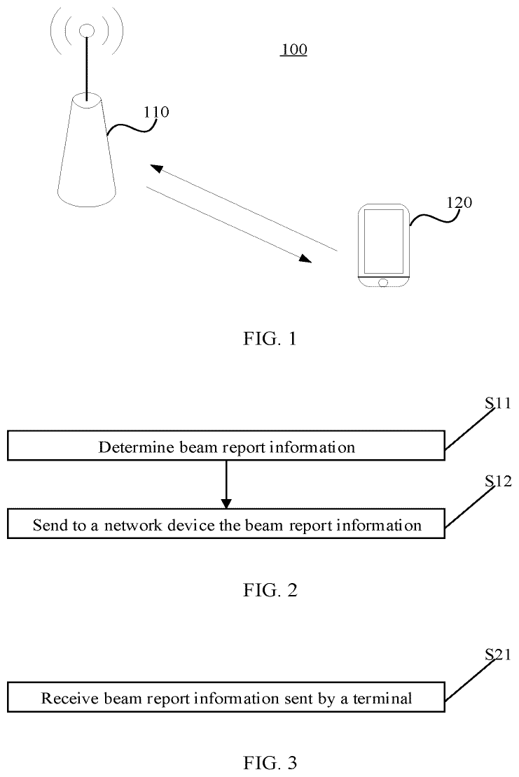

The communication method involved in the present disclosure may be applied to the wireless communication system 100 shown in FIG. 1. The network system may include a network device 110 and a terminal 120. It may be understood that the wireless communication system shown in FIG. 1 is only for schematic illustration, and the wireless communication system may further include other network devices, such as a core network device, a wireless relay device and a wireless backhaul device, which are not drawn in FIG. 1. The quantity of the network devices and the quantity of the terminals included in the wireless communication system are not limited in the embodiments of the present disclosure.

It can be further understood that the wireless communication system in the embodiments of the present disclosure is a network that provides wireless communication functions. The wireless communication system may employ different communication technologies, such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (SC-FDMA), and carrier sense multiple access with collision avoidance. According to capacities, speeds, delays and other factors of different networks, the networks may be divided into a 2th generation (2G) network, a 3rd generation (3G) network, a 4th generation (4G) network, or a future evolved network, such as a 5th generation (5G) wireless communication system network, and the 5G network may also be referred to as new radio (NR). For convenience of description, the wireless communication network may be referred to as network for short sometimes in the present disclosure.

Further, the network device 110 involved in the disclosure may also be referred to as radio access network device. The radio access network device may be a base station, an evolved node B (eNB), a home base station, an access point (AP) in a wireless fidelity (WIFI) system, a wireless relay node, a wireless backhaul node, a transmission point (TP) or a transmission and reception point (TRP), etc., or a generation node B (gNB) in an NR system, or an assembly or part of devices, etc. that constitute a base station. In addition, in a case of a vehicle-to-everything (V2X) communication system, the network device may be a vehicle-mounted device. It should be understood that in the embodiments of the present disclosure, specific technologies and specific device forms used for the network device are not limited.

Further, the terminal 120 involved in the disclosure may also be referred to as terminal device, user equipment (UE), mobile station (MS), mobile terminal (MT), etc., which is a device that provides voice and/or data connectivity for a user. For instance, the terminal may be a handheld device, a vehicle-mounted device, etc. having a wireless connection function. At present, some instances of the terminal include a mobile phone, a pocket personal computer (PPC), a palm computer, a personal digital assistant (PDA), a laptop computer, a tablet computer, a wearable device, and a vehicle-mounted device. In addition, in a case of a vehicle-to-everything (V2X) communication system, the terminal device may be a vehicle-mounted device. It should be understood that in the embodiments of the present disclosure, specific technologies and specific device forms used for the terminal are not limited.

In the embodiments of the present disclosure, the network device 110 and the terminal 120 may adopt any feasible wireless communication technology to achieve mutual data transmission. The transmission channel corresponding to the data sent by the network device 110 to the terminal 120 is referred to as a downlink channel (downlink, DL), and the transmission channel corresponding to the data sent by the terminal 120 to the network device 110 is referred to as an uplink channel (uplink, UL). It can be understood that the network device involved in the embodiments of the present disclosure may be a base station. Of course, the network device may also be any other possible network device, and the terminal may be any possible terminal, which is not limited by the present disclosure.

In NR, especially when the communication frequency band is in frequency range 2, since high-frequency channels attenuate rapidly, it is necessary to use beam-based transmission and reception to ensure coverage range.

In some beam management processes, the network device configures a reference signal resource set for beam measurement. The terminal measures the reference signal resources in the reference signal resource set. The terminal may report identifiers of some relatively strong reference signal resources thereof, along with the corresponding L1-RSRPs and/or L1-SINRs to the network device. The identifier is, for example, an identity identifier (identity, ID).

In the current traditional manner, the reference signal resource set configured by the network device includes X reference signals, and each reference signal corresponds to a different transmitting beam of the network device. For each reference signal, the terminal needs to use all receiving beams to measure the reference signal, so as to obtain the beam measurement qualities corresponding to all receiving beams. In some cases, one or more best beam measurement qualities and/or beam identifiers corresponding to the best beam measurement qualities may be determined. Therefore, the number of beam pairs that the terminal needs to measure is M*N. M represents the number of transmitting beams of the network device, and N is the number of receiving beams of the terminal. Of course, if periodic beam measurement reporting is configured, the terminal needs to perform the measurement for the reference signal of each period and report the beam quality information to the network device.

In some cases, in order to reduce the number of beam pairs measured by the terminal, an AI model may be used for performing beam prediction. Currently, the beam ID predicted by the AI model is relatively accurate, but the beam quality is not very accurate. For example, the beam quality is L1-RSRP and/or L1-SINR. Of course, the AI model may also be replaced by a machine learning (ML) model.

For the AI model that adopts the spatial domain beam prediction manner, the terminal may measure the beam measurement qualities of some beams and predict the beam information of all beams. For example, the beams measured by the terminal are denoted as a set B, and the beams output by the AI model are denoted as a set A. Assuming that the set B is a subset of the set A, then among the K preferred beams output by the AI model, there may be one or more beams belonging to the set B. The beam qualities corresponding to the K preferred beams may include both the situation where the qualities are measured by the terminal and the situation where the qualities are predicted by the AI model, or only the situation where the qualities are predicted by the AI model, or only the situation where the qualities are measured by the terminal. In this case, when the terminal reports the beam qualities obtained in different ways, how to inform the network device of the accuracy of each beam quality is a problem that needs to be solved.

Therefore, the present disclosure provides a communication method and apparatus, a device and a storage medium. By carrying beam accuracy information in the beam report information sent to the network device, it can indicate whether the beam quality of the corresponding beam is accurate, thereby improving the accuracy of the beam prediction model for beam prediction.

In some cases, in order to reduce the number of beam pairs measured by the terminal, an artificial intelligence (AI) model may be used for performing beam prediction. However, the beam quality predicted by the AI model is not very accurate. In addition, among the preferred K beams or beam pairs output by the AI model, for the beam quality of each beam, it is possible that the beam qualities of some beams are obtained through measurement, while the beam qualities of some other beams are predicted by the AI model.

Therefore, how the terminal informs the network device of the accuracy of the beam quality is a problem that needs to be solved.

In order to overcome the problem existing in the related art, the present disclosure provides a communication method and apparatus, a device and a storage medium.

FIG. 2 is a flow chart of a communication method shown according to an exemplary embodiment. As shown in FIG. 2, the method is applied to a terminal and may include the following steps.

In step S11, beam report information is determined.

In some embodiments, the terminal determines the beam report information. The beam report information includes beam quality information and beam accuracy information. The beam accuracy information is used to indicate a degree of accuracy of the beam quality information. The beam quality information may be used to describe the beam quality of the beam.

For example, a beam prediction model is running on the terminal. It can be understood that the beam prediction model may be an AI model, the input of the beam prediction model may be the beam information of set B measured by the terminal, and the beam information of set A is output. For example, the beam information may include beam quality information. Then the beam report information may include beam quality information of the beams in set A, and beam accuracy information for indicating the degree of accuracy of the corresponding beam quality information.

For example, the beam information in set A may be the beam information of all beams output by the beam prediction model. All beams may be all beams included in set A. For another example, the beam information in set A may be the beam information of K preferred beams in set A. The K preferred beams may be beams of which beam qualities satisfy a condition determined according to the output of the beam prediction model. For example, when it is determined that the beam quality of a beam meets a beam quality threshold, the beam may be determined to be a preferred beam. Alternatively, the beams are sorted according to the beam quality from high to low, and the top K beams in the ranking are selected as the preferred beams. It can be understood that the specific method for determining the preferred beams is not limited in the present disclosure. The beam information may include at least one of the beam identifier and/or the beam quality information. The identifier may be, for example, an ID or an index.

The beam involved in the present disclosure is a “beam”. Performing beam measurement may refer to measuring the reference signal in order to measure the L1-RSRP and/or L1-SINR corresponding to the reference signal. The reference signal may include a synchronization signal block (SSB), a channel state information reference signal (CSI-RS) and/or a sounding reference signal (SRS). The beam indication for the beam may be an indication of the transmission configuration indication (TCI) state. The TCI state may be used to inform the terminal that the beam used for receiving the physical downlink control channel (PDCCH) and/or the demodulation reference signal (DMRS) thereof, the physical downlink shared channel (PDSCH) and/or the DMRS thereof is the same receiving beam as that for receiving which SSB or CSI-RS sent by the network device; or, the TCI state may be used to inform the terminal that the beam used for sending the physical uplink control channel (PUCCH) and/or the demodulation reference signal (DMRS) thereof, the physical uplink shared channel (PDSCH) and/or the DMRS thereof is the transmitting beam corresponding to the same receiving beam as that for receiving which SSB or CSI-RS sent by the network device, or the same transmitting beam as that for transmitting which SRS by the terminal device.

The TCI state includes at least one quasi co-location (QCL) type, such as QCL Type A, QCL Type B, QCL Type C and QCL Type D. QCL Type D is reception parameter information, which may be commonly referred to as a beam. QCL Type A, QCL Type B and QCL Type C include at least one parameter related to Doppler shift, Doppler spread, average delay and delay spread. For the uplink beam, the beam indication may be spatial relation information, spatial filter information (spatial filter parameter) or an uplink TCI state.

In some embodiments, in the case that the beam prediction model is a spatial prediction, the terminal measures the L1-RSRP of set B and inputs it into the beam prediction model. The beam prediction model may predict the L1-RSRP of set A.

The relationships between the set B and set A include the following two types.

The first relationship is that set B is a subset of set A. For example, if set A contains 32 reference signals (each reference signal corresponds to one beam direction), then set B contains some of the reference signals in set A. For example, set B contains 8 of the 32 reference signals.

The second relationship is that set B is a wide beam and set A is a narrow beam. For example, set A contains 32 reference signals (each reference signal corresponds to one beam direction, and the 32 reference signals cover a direction of 120 degrees). Set B contains another Y reference signals, for example, Y=8. These Y reference signals also cover a direction of 120 degrees, that is, the beam direction of each reference signal in set B covers the beam direction of multiple reference signals in set A. It can be understood that the 32/Y reference signals in set A are in a QCL Type D relationship with a same reference signal in set B.

In some embodiments, in the case that the beam prediction model is a time domain prediction, the terminal measures the L1-RSRP of set B in the historical time and inputs it into the beam prediction model to predict the beam information of the beams in set A at a future moment. In addition to the above two relationships between set B and set A, there is another relationship that set B and set A are the same.

In step S12, beam report information is sent to the network device.

In some embodiments, the terminal may send the beam report information determined in S11 to the network device.

The present disclosure carries beam accuracy information in the beam report information sent to the network device, which can indicate whether the beam quality of the corresponding beam is accurate, thereby improving the accuracy of the beam prediction model for the beam prediction.

In the communication method provided by the embodiments of the present disclosure, the beam accuracy information indicating the degree of accuracy of the beam quality information includes: indicating that the beam quality information is inaccurate, or indicating at least one of the following degrees of accuracy of the beam quality information: indicating that the beam quality information is accurate; indicating that the beam quality information is an accuracy rate predicted by the terminal through a beam prediction model; and indicating that the beam quality information is a specified beam quality feature, where the beam quality feature represents a difference between a predicted beam quality and a measured beam quality.

In some embodiments, the beam accuracy information indicating the degree of accuracy of the beam quality information includes: indicating that the beam quality information is inaccurate; or indicating at least one of following: indicating that the beam quality information is accurate, indicating that the beam quality information is the accuracy rate predicted by the terminal through the beam prediction model, and indicating that the beam quality information is the specified beam quality feature. The beam quality feature represents the difference between the predicted beam quality and the measured beam quality.

In some embodiments, the beam accuracy information may use one bit to indicate the degree of accuracy of the beam quality information. For example, if the bit is a first value, it indicates that the beam quality information is accurate; if the bit is a second value, it indicates that the beam quality information is inaccurate.

For example, the beam accuracy information is 1 bit, which is used to indicate whether the beam quality information is accurate or inaccurate. The beam quality information being accurate means that the beam quality information is obtained by terminal through measurement. The beam quality information being inaccurate means that the beam quality information is predicted by the terminal through a beam prediction model. For example, 1 bit may be set to 1 to indicate that the beam quality information is accurate, and 1 bit may be set to 0 to indicate that the beam quality information is inaccurate; or, 1 bit may be set to 0 to indicate that the beam quality information is accurate, and 1 bit may be set to 1 to indicate that the beam quality information is inaccurate. The present disclosure does not limit the correspondence between the specific value of the bit and the degree of accuracy of the beam quality information.

In some embodiments, the beam accuracy information may use a plurality of bits to indicate the degree of accuracy of the beam quality information. The beam accuracy information may use multiple bits to indicate that the beam quality information is accurate, or to indicate that the beam quality information is the accuracy rate predicted by the terminal through the beam prediction model.

For example, 2 bits may be used to indicate that the beam quality information is accurate, or to indicate the beam quality information as the accuracy rate predicted by the terminal through the beam prediction model. It can be understood that the beam quality information being accurate means that the beam quality information is obtained by the terminal through measurement. Of course, the beam quality information being accurate may also be considered that the accuracy rate of the beam quality information is 100%.

For example, 2 bits being “11” indicates that the beam quality information is accurate, that is, the accuracy rate of the beam quality information is 100%, which also represents that the beam quality information is measured by the terminal. For another example, 2 bits being “10” may indicate that the accuracy rate of the beam quality information is 80%, which also represents that the beam quality information is predicted by the terminal through a beam prediction model. In this case, it may be considered that the accuracy rate of the beam quality information is relatively high. For another example, 2 bits being “01” may indicate that the accuracy rate of the beam quality information is 60%, which also represents that the beam quality information is predicted by the terminal through a beam prediction model. In this case, it may be considered that the accuracy rate of the beam quality information is acceptable and is within a moderate range. For another example, 2 bits being “00” may indicate that the accuracy rate of the beam quality information is 50%, which also represents that the beam quality information is predicted by the terminal through a beam prediction model. In this case, it may be considered that the accuracy of the beam quality information is not high.

As can be seen from above, in response to the accuracy rate of the beam quality information being 100%, it means that the beam quality information is obtained by measurement by the terminal; in response to the accuracy of the beam quality information being less than 100%, it means that the beam quality information is predicted by the terminal through a beam prediction model.

Of course, the specific accuracy rates of the degree of accuracy of the beam quality information indicated by the above-mentioned multi-bit may be arbitrarily set and adjusted according to the actual situations, which is not limited by the present disclosure.

In some embodiments, the beam accuracy information may use a plurality of bits to indicate the degree of accuracy of the beam quality information. The beam accuracy information may use multiple bits to indicate that the beam quality information is accurate, or to indicate the beam quality information as a specified beam quality feature. The beam quality feature represents the difference between the predicted beam quality and the measured beam quality. It can be understood that the difference between the predicted beam quality and the measured beam quality may implicitly represent the accuracy rate of the beam quality information.

For example, 2 bits may be used to indicate that the beam quality information is accurate, or to indicate the beam quality information as the specified beam quality feature. It can be understood that the beam quality information being accurate means that the beam quality information is measured by the terminal. Of course, the beam quality information being may also be considered that the accuracy rate of the beam quality information is 100%.

For example, 2 bits being “11” indicates that the beam quality information is accurate, that is, the accuracy rate of the beam quality information is 100%, which also represents that the beam quality information is measured by the terminal. For another example, 2 bits being “10” may indicate the beam quality information as beam quality feature 1, which also represents that the beam quality information is predicted by the terminal through a beam prediction model. For another example, 2 bits being “01” may indicate the beam quality information as beam quality feature 2, which also indicates that the beam quality information is predicted by the terminal through a beam prediction model. For another example, 2 bits being “00” may indicate the beam quality information as beam quality feature 3, which also represents that the beam quality information is predicted by the terminal through a beam prediction model.

The beam quality feature 1, beam quality feature 2 and beam quality feature 3 all indicate that the beam quality information is predicted by the terminal through the beam prediction model. However, different beam quality features may implicitly indicate different accuracy rates of beam quality information. As can be seen from above, in response to the case that the beam quality information is accurate, it indicates that the beam quality information is measured by the terminal; in response to the case that the beam quality information is a specified beam quality feature, it indicates that the beam quality information is predicted by the terminal through the beam prediction model.

Of course, the specific beam quality features indicated by the above multi-bits may be arbitrarily set and adjusted according to actual situations, which is not limited by the present disclosure.

In some embodiments, the indication manner of the beam accuracy information may be any combination of indicating that the beam quality information is inaccurate, indicating that the beam quality information is accurate, indicating the beam quality information as the accuracy rate predicted by the terminal through the beam prediction model, and indicating the beam quality information as a specified beam quality feature, which is not limited by the present disclosure.

The present disclosure provides various forms of beam accuracy information to indicate the degree of accuracy of beam quality information. By sending the beam accuracy information to the network device, it can indicate whether the beam quality of the corresponding beam is accurate, thereby improving the accuracy of the beam prediction model for beam prediction.

In the communication method provided by the embodiments of the present disclosure, the beam quality feature may include any one of the following: a difference value between the predicted beam quality and the measured beam quality; an average of difference values between the predicted beam qualities and the measured beam qualities; a variance of difference values between the predicted beam qualities and the measured beam qualities.

In some embodiments, the beam quality feature may include a difference value between a predicted beam quality and a measured beam quality.

For example, the beam quality feature 1 may indicate that the difference value between the predicted beam quality and the measured beam quality is within range 1. Range 1 may be less than or equal to A1 decibel (dB), for example, the difference value between the predicted beam quality and the measured beam quality is less than or equal to A1 dB. Alternatively, range 1 may also be between A1 dB and A2 dB, for example, the difference value between the predicted beam quality and the measured beam quality is within (A1 dB, A2 dB). Alternatively, range 1 may also be greater than or equal to A2 dB, for example, the difference value between the predicted beam quality and the measured beam quality is greater than or equal to A2 dB. A2 is greater than A1.

For another example, beam quality feature 2 may indicate that the difference value between the predicted beam quality and the measured beam quality is within range 2. Range 2 may be less than or equal to B1 dB, for example, the difference value between the predicted beam quality and the measured beam quality is less than or equal to B1 dB. Alternatively, range 2 may also be between B1 dB and B2 dB, for example, the difference value between the predicted beam quality and the measured beam quality is within the range of (B1 dB, B2 dB). Alternatively, range 2 may also be greater than or equal to B2 dB, for example, the difference value between the predicted beam quality and the measured beam quality is greater than or equal to B2 dB. B2 is greater than B1.

For another example, beam quality feature 3 may indicate that the difference value between the predicted beam quality and the measured beam quality is within range 3. Range 3 may be less than or equal to C1 dB, for example, the difference value between the predicted beam quality and the measured beam quality is less than or equal to C1 dB. Alternatively, range 3 may also be between C1 dB and C2 dB, for example, the difference value between the predicted beam quality and the measured beam quality is within the range of (C1 dB, C2 dB). Alternatively, range 3 may also be greater than or equal to C2 dB, for example, the difference value between the predicted beam quality and the measured beam quality is greater than or equal to C2 dB. C2 is greater than C1.

It can be understood that A1 dB and A2 dB may be referred to as the first difference value threshold, B1 dB and B2 dB may be referred to as the second difference value threshold, C1 dB and C2 dB may be referred to as the third difference value threshold. In some embodiments, the magnitude relationship among the first difference value threshold, the second difference value threshold, and the third difference value threshold may be preset. For example, it is assumed that the first difference value threshold<the second difference value threshold<the third difference value threshold. In response to the difference value between the predicted beam quality and the measured beam quality being within range 1, it may be considered that the accuracy of the beam quality information is relatively high; in response to the difference value between the predicted beam quality and the measured beam quality being within range 2, it may be considered that the accuracy of the beam quality information is acceptable and within a moderate range; in response to the difference value between the predicted beam quality and the measured beam quality being within range 3, it may be considered that the accuracy of the beam quality information is not high. Of course, each range may also be selected to correspond to a different interval according to actual conditions. For example, range 1 may refer to the difference value≤A1 dB, A1 dB<the difference value<A2 dB, or the difference value≥A2 dB; range 2 may refer to the difference value≤B1 dB, B1 dB<the difference value<B2 dB, or the difference value≥B2 dB; range 3 may refer to the difference value≤C1 dB, C1 dB<the difference value<C2 dB, or the difference value≥C2 dB.

Of course, the above is only an exemplary description. The present disclosure does not limit the magnitude relationship among the first difference value threshold, the second difference value threshold and the third difference value threshold, nor does it limit the specific range corresponding to each specified beam quality feature, and even less does it limit the accuracy rate of the beam quality information corresponding to each specified beam quality feature.

In some embodiments, the beam quality characteristic may include an average of the difference values between the predicted beam qualities and the measured beam qualities.

For example, the beam quality feature 1 may indicate that the average of the difference values between the predicted beam qualities and the measured beam qualities is within range 4. Range 4 may be less than or equal to A3 dB, for example, the average of the difference values between the predicted beam qualities and the measured beam qualities is less than or equal to A3 dB. Alternatively, range 4 may also be between A3 dB and A4 dB, for example, the average of the difference values between the predicted beam qualities and the measured beam qualities is within (A3 dB, A4 dB). Alternatively, range 4 may also be greater than or equal to A4 dB, for example, the average of the difference values between the predicted beam qualities and the measured beam qualities is greater than or equal to A4 dB. A4 is greater than A3.

For another example, beam quality feature 2 may indicate that the average of the difference values between the predicted beam qualities and the measured beam qualities is within range 5. Range 5 may be less than or equal to B3 dB, for example, the average of the difference values between the predicted beam qualities and the measured beam qualities is less than or equal to B3 dB. Alternatively, range 5 may also be between B3 dB and B4 dB, for example, the average of difference values between the predicted beam qualities and the measured beam qualities is within the range of (B3 dB, B4 dB). Alternatively, range 5 may also be greater than or equal to B4 dB, for example, the average of the difference values between the predicted beam qualities and the measured beam qualities is greater than or equal to B4 dB. B4 is greater than B3.

For another example, beam quality feature 3 may indicate that the average of the difference values between the predicted beam qualities and the measured beam qualities is within range 6. Range 6 may be less than or equal to C3 dB, for example, the average of the difference values between the predicted beam qualities and the measured beam qualities is less than or equal to C3 dB. Alternatively, range 6 may also be between C3 dB and C4 dB, for example, the average of the difference values between the predicted beam qualities and the measured beam qualities is within the range of (C3 dB, C4 dB). Alternatively, range 6 may also be greater than or equal to C4 dB, for example, the average of the difference values between the predicted beam qualities and the measured beam qualities is greater than or equal to C4 dB. C4 is greater than C3.

It can be understood that A3 dB and A4 dB may be referred to as the first average threshold, B3 dB and B4 dB may be referred to as the second average threshold, C3 dB and C4 dB may be referred to as the third average threshold. In some embodiments, the magnitude relationship among the first average threshold, the second average threshold, and the third average threshold may be preset. For example, it is assumed that the first average threshold<the second average threshold<the third average threshold. In response to the average of the difference values between the predicted beam qualities and the measured beam qualities being within range 4, it may be considered that the accuracy of the beam quality information is relatively high; in response to the average of the difference values between the predicted beam qualities and the measured beam qualities being within range 5, it may be considered that the accuracy of the beam quality information is acceptable and within a moderate range; in response to the average of the difference values between the predicted beam qualities and the measured beam qualities being within range 6, it may be considered that the accuracy of the beam quality information is not high. Of course, each range may also be selected to correspond to a different interval according to actual conditions. For example, range 4 may refer to the average of difference values≤A3 dB, A3 dB<the average of difference values<A4 dB, or the average of difference values≥A4 dB; range 5 may refer to the average of difference values≤B3 dB, B3 dB<the average of difference values<B4 dB, or the average of difference values≥B4 dB; range 6 may refer to the average of difference values≤C3 dB, C3 dB<the average of difference values<C4 dB, or the average of difference values≥C4 dB.

Of course, the above is only an exemplary description. The present disclosure does not limit the magnitude relationship among the first average threshold, the second average threshold and the third average threshold, nor does it limit the specific range corresponding to each specified beam quality feature, and even less does it limit the accuracy rate of the beam quality information corresponding to each specified beam quality feature.

In some embodiments, the beam quality feature may include a variance of the difference values between the predicted beam qualities and the measured beam qualities.

For example, the beam quality feature 1 may indicate that the variance of the difference values between the predicted beam qualities and the measured beam qualities is within range 7. Range 7 may be less than or equal to A5 dB, for example, the variance of the difference values between the predicted beam qualities and the measured beam qualities is less than or equal to A5 dB. Alternatively, range 7 may also be between A5 dB and A6 dB, for example, the variance of the difference values between the predicted beam qualities and the measured beam qualities is within (A5 dB, A6 dB). Alternatively, range 7 may also be greater than or equal to A5 dB, for example, the variance of the difference values between the predicted beam qualities and the measured beam qualities is greater than or equal to A6 dB. A6 is greater than A5.

For another example, beam quality feature 2 may indicate that the variance of the difference values between the predicted beam qualities and the measured beam qualities is within range 8. Range 8 may be less than or equal to B5 dB, for example, the variance of the difference values between the predicted beam qualities and the measured beam qualities is less than or equal to B5 dB. Alternatively, range 8 may also be between B5 dB and B6 dB, for example, the variance of difference values between the predicted beam qualities and the measured beam qualities is within the range of (B5 dB, B6 dB). Alternatively, range 8 may also be greater than or equal to B6 dB, for example, the variance of the difference values between the predicted beam qualities and the measured beam qualities is greater than or equal to B6 dB. B6 is greater than B5.

For another example, beam quality feature 3 may indicate that the variance of the difference values between the predicted beam qualities and the measured beam qualities is within range 9. Range 9 may be less than or equal to C5 dB, for example, the variance of the difference values between the predicted beam qualities and the measured beam qualities is less than or equal to C5 dB. Alternatively, range 9 may also be between C5 dB and C6 dB, for example, the variance of the difference values between the predicted beam qualities and the measured beam qualities is within the range of (C5 dB, C6 dB). Alternatively, range 9 may also be greater than or equal to C6 dB, for example, the variance of the difference values between the predicted beam qualities and the measured beam qualities is greater than or equal to C6 dB. C6 is greater than C5.

It can be understood that A5 dB and A6 dB may be referred to as the first variance threshold, B5 dB and B6 dB may be referred to as the second variance threshold, C5 dB and C6 dB may be referred to as the third variance threshold. In some embodiments, the magnitude relationship among the first variance threshold, the second variance threshold, and the third variance threshold may be preset. For example, it is assumed that the first variance threshold<the second variance threshold<the third variance threshold. In response to the variance of the difference values between the predicted beam qualities and the measured beam qualities being within range 7, it may be considered that the accuracy of the beam quality information is relatively high; in response to the variance of the difference values between the predicted beam qualities and the measured beam qualities being within range 8, it may be considered that the accuracy of the beam quality information is acceptable and within a moderate range; in response to the variance of the difference values between the predicted beam qualities and the measured beam qualities being within range 9, it may be considered that the accuracy of the beam quality information is not high. Of course, each range may also be selected to correspond to a different interval according to actual conditions. For example, range 7 may refer to the variance of difference values≤A5 dB, A5 dB<the variance of difference values<A6 dB, or the variance of difference values≥A6 dB; range 8 may refer to the variance of difference values≤B5 dB, B5 dB<the variance of difference values<B6 dB, or the variance of difference values≥B6 dB; range 9 may refer to the variance of difference values≤C5 dB, C5 dB<the variance of difference values<C6 dB, or the variance of difference values≥C6 dB.

Of course, the above is only an exemplary description. The present disclosure does not limit the magnitude relationship among the first variance threshold, the second variance threshold and the third variance threshold, nor does it limit the specific range corresponding to each specified beam quality feature, and even less does it limit the accuracy rate of the beam quality information corresponding to each specified beam quality feature.

In some embodiments, the measured beam quality may be obtained by actual measurement by the terminal. For example, the terminal calculates the difference value, the average of the difference values and/or the variance of the difference values based on the beam qualities measured for the beams in set B and the beam qualities predicted by the beam prediction model corresponding to the beams in set B, so as to obtain the specified beam quality feature.

In some embodiments, in response to the case that the beam prediction model is a spatial prediction, the relationship between set B and set A may be that set B is a wide beam and set A is a narrow beam. Regarding the measured beam quality, it can be obtained by the terminal based on historical experience. For example, none of the beam qualities of the beams in set A predicted by the terminal is actually measured.

In some embodiments, with respect to the measured beam quality, in response to the case that the beam prediction model is a time domain prediction, the beam prediction model uses the beam quality at the historical time to predict the beam quality at the future time. It can be understood that the beam qualities corresponding to the future time of the beams are all predicted by the beam prediction model, and there is no beam quality actually measured by the terminal. This is because the terminal at the current moment is unable to measure the beams at the future time.

The present disclosure provides a variety of different forms of beam quality features to indicate the degree of accuracy of beam quality information. By sending beam accuracy information to a network device, it can indicate whether the beam quality of the corresponding beam is accurate, thereby improving the accuracy of the beam prediction model for beam prediction.

In the communication method provided by the embodiments of the present disclosure, the beam accuracy information is further used to indicate at least one of the following: indicating the degree of accuracy of the beam quality information corresponding to any one beam in a beam set, where the beam in the beam set is a beam included in the beam report information; indicating the degree of accuracy of the beam quality information corresponding to any number of beams in the beam set; indicating the degree of accuracy of the beam quality information corresponding to all beams in the beam set; and indicating the degree of accuracy of the beam quality information corresponding to a beam in any one or more beam subsets, where one beam subset corresponds to at least one beam at one time point.

In some embodiments, the beam accuracy information is further used to indicate the degree of accuracy of beam quality information corresponding to any beam in the beam set, where the beam in the beam set is the beam included in the beam report information.

For example, the beam accuracy information in the beam report information may indicate, for any one of the beams included in the beam report information, the degree of accuracy of the beam quality information corresponding to that beam. Of course, it may also be considered that the beam accuracy information may independently indicate, for each beam in the beam report information, the degree of accuracy of the beam quality information corresponding to that beam.

In some embodiments, the beam accuracy information is further used to indicate the degree of accuracy of beam quality information corresponding to any number of beams in the beam set.

For example, the beam accuracy information in the beam report information may indicate, for any multiple beams included in the beam report information, the degree of accuracy of the beam quality information corresponding to these multiple beams. Of course, it may also be considered that the beam accuracy information may collectively indicate, for any multiple beams in the beam report information, the degree of accuracy of the beam quality information corresponding to these beams.

In some embodiments, the beam accuracy information is further used to indicate the degree of accuracy of the beam quality information corresponding to all beams in the beam set.

For example, the beam accuracy information in the beam report information may indicate, for all beams included in the beam report information, the degree of accuracy of the beam quality information corresponding to all beams. Of course, it may also be considered that the beam accuracy information may collectively indicate, for all beams in the beam report information, the degree of accuracy of the beam quality information corresponding to all beams.

In some embodiments, the beam accuracy information is further used to indicate the degree of accuracy of beam quality information corresponding to a beam in any one or more beam subsets, where one beam subset corresponds to at least one beam at one time point.

For example, the beam accuracy information in the beam report information may indicate, for the beam in any one or more beam subsets, the degree of accuracy of the beam quality information corresponding to any one or more beam subsets. One beam subset corresponds to at least one beam at one time point. That is, the beam accuracy information may perform indication for the beam quality information at one or more time points among the beam quality information at multiple time points contained in one beam report.

For example, when one beam report includes beam quality information at multiple time points, the beam quality information for each time point may be regarded as a beam subset, and one piece of beam accuracy information is indicated for each beam subset. This is more applicable to the beam report information where the beam prediction model is a time-domain prediction model. In this case, the beam information predicted by the beam prediction model may include beam measurement information at multiple time points. In the beam measurement information at each time point, the beam measurement information at some time points may be obtained by the terminal through measurement, and the beam measurement information at some other time points may be obtained by the terminal through prediction by using the beam prediction model.

The present disclosure provides a variety of different manners for indicating beam accuracy information to indicate the degree of accuracy of the beam quality information. By sending beam accuracy information to the network device, it can indicate whether the beam quality of the corresponding beam is accurate, thereby improving the accuracy of the beam prediction model for beam prediction.

In the communication method provided by the embodiments of the present disclosure, the beam quality information may include at least one piece of the following information: a layer 1 reference signal received power (L1-RSRP); and a layer 1 signal to interference plus noise ratio (L1-SINR).

In some embodiments, the beam quality information may include L1-RSRP.

In some embodiments, the beam quality information may include L1-SINR.

The present disclosure provides a variety of different beam quality information. By sending beam accuracy information to the network device, it can indicate whether the beam quality of the corresponding beam is accurate, thereby improving the accuracy of the beam prediction model for beam prediction.

In the communication method provided by the embodiments of the present disclosure, the beam report information further includes: a beam identifier, and the beam identifier includes a transmitting beam identifier and/or a receiving beam identifier.

In some embodiments, the beam report information may further include a beam identifier, which may be, for example, an ID or an index.

In some embodiments, the beam identifier may include a transmitting beam identifier. For example, the transmitting beam identifier may be a transmitting (transmit or transport, Tx) beam ID.

In some embodiments, the beam identifier may include a receiving beam identifier. For example, the receiving beam identifier may be a receiving (receive, Rx) beam ID.

The present disclosure provides that beam report information may further include a beam identifier. By sending beam accuracy information to the network device, it can indicate whether the beam quality of the beam corresponding to the beam identifier is accurate, thereby improving the accuracy of the beam prediction model for beam prediction.

In the communication method provided by the embodiments of the present disclosure, the transmitting beam identifier is a synchronization signal block (SSB) identifier or a channel state information reference signal (CSI-RS) identifier.

In some embodiments, the transmitting beam identifier may be an SSB identifier. For example, the Tx beam ID may be an SSB index.

In some embodiments, the transmitting beam ID may be a channel state information reference signal (CSI-RS) identifier. For example, the Tx beam ID may be a CSI-RS index.

The present disclosure provides a variety of different transmitting beam identifiers. By sending beam accuracy information to a network device, it can indicate whether the beam quality of the transmitting beam corresponding to the transmitting beam identifier is accurate, thereby improving the accuracy of the beam prediction model for beam prediction.

In the communication method provided by the embodiments of the present disclosure, the beam report information includes at least one set of beams, where beams in a same set are beams that the terminal supports to receive simultaneously; or, beams in a same set are beams that the terminal supports to transmit simultaneously; or, beams in a same set are beams that the terminal does not support to receive simultaneously; or, beams in a same set are beams that the terminal does not support to transmit simultaneously.

In some embodiments, the beam report information may include at least one set of beams, where the beams in the same set are beams that the terminal supports or does not support for simultaneous reception or simultaneous transmission.

In some embodiments, beams in the same set are beams that the terminal supports to receive simultaneously.

In some embodiments, beams in the same set are beams that the terminal supports to transmit simultaneously.

It can be understood that the beams in the same set are beams that the terminal supports for simultaneous reception and/or simultaneous transmission, which may correspond to the group based beam reporting attribute. Alternatively, the group based beam reporting attribute is enabled. This attribute indicates that the beams corresponding to multiple reference signal (RS) IDs within one group may be simultaneously received and/or simultaneously transmitted by the terminal. Of course, this attribute may also indicate that the beams corresponding to two RS IDs from different groups may be simultaneously received and/or simultaneously transmitted by the terminal.

In some embodiments, beams in the same set are beams that the terminal does not support to receive simultaneously.

In some embodiments, beams in the same set are beams that the terminal does not support to transmit simultaneously.

For example, the beams in the same set are beams that the terminal does not support for simultaneous reception and/or simultaneous transmission, which may correspond to the non-group based beam reporting attribute. Alternatively, the group based beam reporting attribute is disabled.

The present disclosure can be applied to terminals with various attributes. By sending beam accuracy information to the network device, it can indicate whether the beam quality of the transmitting beam corresponding to the transmitting beam identifier is accurate, thereby improving the accuracy of the beam prediction model for beam prediction.

Based on the same concept, the present disclosure further provides a communication method executed at a network device side.

FIG. 3 is a flow chart of another communication method shown according to an exemplary embodiment. As shown in FIG. 3, the method is applied to a network device and may include the following steps.

In step S21, beam report information sent by a terminal is received.

In some embodiments, the network device receives beam report information sent by the terminal. The beam report information includes beam quality information and beam accuracy information. The beam accuracy information is used to indicate an degree of accuracy of the beam quality information. The beam quality information may be used to describe the beam quality of the beam.

For example, a beam prediction model is running on the terminal. It can be understood that the beam prediction model may be an AI model, the input of the beam prediction model may be the beam information of set B measured by the terminal, and the beam information of set A is output. For example, the beam information may include beam quality information. Then the beam report information may include beam quality information of the beams in set A, and beam accuracy information for indicating the degree of accuracy of the corresponding beam quality information.

For example, the beam information in set A may be the beam information of all beams output by the beam prediction model. All beams may be all beams included in set A. For another example, the beam information in set A may be the beam information of K preferred beams in set A. The K preferred beams may be beams of which beam qualities satisfy a condition determined according to the output of the beam prediction model. For example, when it is determined that the beam quality of a beam meets a beam quality threshold, the beam may be determined to be a preferred beam. Alternatively, the beams are sorted according to the beam quality from high to low, and the top K beams in the ranking are selected as the preferred beams. It can be understood that the specific method for determining the preferred beams is not limited in the present disclosure. The beam information may include at least one of the beam identifier and/or the beam quality information. The identifier may be, for example, an ID or an index.

The present disclosure carries beam accuracy information in the beam report information sent to the network device, which can indicate whether the beam quality of the corresponding beam is accurate, thereby improving the accuracy of the beam prediction model for the beam prediction.

In the communication method provided by the embodiments of the present disclosure, the beam accuracy information indicating the degree of accuracy of the beam quality information includes: indicating that the beam quality information is inaccurate, or indicating at least one of the following degrees of accuracy of the beam quality information: indicating that the beam quality information is accurate; indicating that the beam quality information is an accuracy rate predicted by the terminal through a beam prediction model; and indicating that the beam quality information is a specified beam quality feature, where the beam quality feature represents a difference between a predicted beam quality and a measured beam quality.

In some embodiments, the beam accuracy information indicating the degree of accuracy of the beam quality information includes: indicating that the beam quality information is inaccurate; or indicating at least one of the following: indicating that the beam quality information is accurate, indicating that the beam quality information is the accuracy rate predicted by the terminal through the beam prediction model, and indicating that the beam quality information is the specified beam quality feature. The beam quality feature represents the difference between the predicted beam quality and the measured beam quality.

In some embodiments, the beam accuracy information may use one bit to indicate the degree of accuracy of the beam quality information. For example, if the bit is a first value, it indicates that the beam quality information is accurate; if the bit is a second value, it indicates that the beam quality information is inaccurate.

For example, the beam accuracy information is 1 bit, which is used to indicate whether the beam quality information is accurate or inaccurate. The beam quality information being accurate means that the beam quality information is obtained by terminal through measurement. The beam quality information being inaccurate means that the beam quality information is predicted by the terminal through a beam prediction model. For example, 1 bit may be set to 1 to indicate that the beam quality information is accurate, and 1 bit may be set to 0 to indicate that the beam quality information is inaccurate; or, 1 bit may be set to 0 to indicate that the beam quality information is accurate, and 1 bit may be set to 1 to indicate that the beam quality information is inaccurate. The present disclosure does not limit the correspondence between the specific value of the bit and the degree of accuracy of the beam quality information.

In some embodiments, the beam accuracy information may use a plurality of bits to indicate the degree of accuracy of the beam quality information. The beam accuracy information may use multiple bits to indicate that the beam quality information is accurate, or to indicate the beam quality information as the accuracy rate predicted by the terminal through the beam prediction model.

For example, 2 bits may be used to indicate that the beam quality information is accurate, or to indicate the beam quality information as the accuracy rate predicted by the terminal through the beam prediction model. It can be understood that the beam quality information being accurate means that the beam quality information is obtained by the terminal through measurement. Of course, the beam quality information being accurate may also be considered that the accuracy rate of the beam quality information is 100%.

For example, 2 bits being “11” indicates that the beam quality information is accurate, that is, the accuracy rate of the beam quality information is 100%, which also represents that the beam quality information is measured by the terminal. For another example, 2 bits being “10” may indicate that the accuracy rate of the beam quality information is 80%, which also represents that the beam quality information is predicted by the terminal through a beam prediction model. In this case, it may be considered that the accuracy rate of the beam quality information is relatively high. For another example, 2 bits being “01” may indicate that the accuracy rate of the beam quality information is 60%, which also represents that the beam quality information is predicted by the terminal through a beam prediction model. In this case, it may be considered that the accuracy rate of the beam quality information is acceptable and is within a moderate range. For another example, 2 bits being “00” may indicate that the accuracy rate of the beam quality information is 50%, which also represents that the beam quality information is predicted by the terminal through a beam prediction model. In this case, it may be considered that the accuracy of the beam quality information is not high.

As can be seen from above, in response to the accuracy rate of the beam quality information being 100%, it means that the beam quality information is obtained by measurement by the terminal; in response to the accuracy of the beam quality information being less than 100%, it means that the beam quality information is predicted by the terminal through a beam prediction model.

Of course, the specific accuracy rates of the degree of accuracy of the beam quality information indicated by the above-mentioned multi-bit may be arbitrarily set and adjusted according to the actual situations, which is not limited by the present disclosure.

In some embodiments, the beam accuracy information may use a plurality of bits to indicate the degree of accuracy of the beam quality information. The beam accuracy information may use multiple bits to indicate that the beam quality information is accurate, or to indicate the beam quality information as a specified beam quality feature. The beam quality feature represents the difference between the predicted beam quality and the measured beam quality. It can be understood that the difference between the predicted beam quality and the measured beam quality may implicitly represent the accuracy rate of the beam quality information.

For example, 2 bits may be used to indicate that the beam quality information is accurate, or to indicate the beam quality information as the specified beam quality feature. It can be understood that the beam quality information being accurate means that the beam quality information is measured by the terminal. Of course, the beam quality information being accurate may also be considered that the accuracy rate of the beam quality information is 100%.

For example, 2 bits being “11” indicates that the beam quality information is accurate, that is, the accuracy rate of the beam quality information is 100%, which also represents that the beam quality information is measured by the terminal. For another example, 2 bits being “10” may indicate the beam quality information as beam quality feature 1, which also represents that the beam quality information is predicted by the terminal through a beam prediction model. For another example, 2 bits being “01” may indicate the beam quality information as beam quality feature 2, which also indicates that the beam quality information is predicted by the terminal through a beam prediction model. For another example, 2 bits being “00” may indicate the beam quality information as beam quality feature 3, which also represents that the beam quality information is predicted by the terminal through a beam prediction model.

The beam quality feature 1, beam quality feature 2 and beam quality feature 3 all indicate that the beam quality information is predicted by the terminal through the beam prediction model. However, different beam quality features may implicitly indicate different accuracy rates of beam quality information. As can be seen from above, in response to the case that the beam quality information is accurate, it indicates that the beam quality information is measured by the terminal; in response to the case that the beam quality information is a specified beam quality feature, it indicates that the beam quality information is predicted by the terminal through the beam prediction model.

Of course, the specific beam quality features indicated by the above multi-bits may be arbitrarily set and adjusted according to actual situations, which is not limited by the present disclosure.

In some embodiments, the indication manner of the beam accuracy information may be any combination of indicating that the beam quality information is inaccurate, indicating that the beam quality information is accurate, indicating the beam quality information as the accuracy rate predicted by the terminal through the beam prediction model, and indicating the beam quality information as a specified beam quality feature, which is not limited by the present disclosure.

The present disclosure provides various forms of beam accuracy information to indicate the degree of accuracy of beam quality information. By sending the beam accuracy information to the network device, it can indicate whether the beam quality of the corresponding beam is accurate, thereby improving the accuracy of the beam prediction model for beam prediction.

In the communication method provided by the embodiments of the present disclosure, the beam quality feature may include any one of the following: a difference value between the predicted beam quality and the measured beam quality; an average of difference values between the predicted beam qualities and the measured beam qualities; a variance of difference values between the predicted beam qualities and the measured beam qualities.

In some embodiments, the beam quality feature may include a difference value between a predicted beam quality and a measured beam quality.

For example, the beam quality feature 1 may indicate that the difference value between the predicted beam quality and the measured beam quality is within range 1. Range 1 may be less than or equal to A1 decibel (dB), for example, the difference value between the predicted beam quality and the measured beam quality is less than or equal to A1 dB. Alternatively, range 1 may also be between A1 dB and A2 dB, for example, the difference value between the predicted beam quality and the measured beam quality is within (A1 dB, A2 dB). Alternatively, range 1 may also be greater than or equal to A2 dB, for example, the difference value between the predicted beam quality and the measured beam quality is greater than or equal to A2 dB. A2 is greater than A1.

For another example, beam quality feature 2 may indicate that the difference value between the predicted beam quality and the measured beam quality is within range 2. Range 2 may be less than or equal to B1 dB, for example, the difference value between the predicted beam quality and the measured beam quality is less than or equal to B1 dB. Alternatively, range 2 may also be between B1 dB and B2 dB, for example, the difference value between the predicted beam quality and the measured beam quality is within the range of (B1 dB, B2 dB). Alternatively, range 2 may also be greater than or equal to B2 dB, for example, the difference value between the predicted beam quality and the measured beam quality is greater than or equal to B2 dB. B2 is greater than B1.

For another example, beam quality feature 3 may indicate that the difference value between the predicted beam quality and the measured beam quality is within range 3. Range 3 may be less than or equal to C1 dB, for example, the difference value between the predicted beam quality and the measured beam quality is less than or equal to C1 dB. Alternatively, range 3 may also be between C1 dB and C2 dB, for example, the difference value between the predicted beam quality and the measured beam quality is within the range of (C1 dB, C2 dB). Alternatively, range 3 may also be greater than or equal to C2 dB, for example, the difference value between the predicted beam quality and the measured beam quality is greater than or equal to C2 dB. C2 is greater than C1.

It can be understood that A1 dB and A2 dB may be referred to as the first difference value threshold, B1 dB and B2 dB may be referred to as the second difference value threshold, C1 dB and C2 dB may be referred to as the third difference value threshold. In some embodiments, the magnitude relationship among the first difference value threshold, the second difference value threshold, and the third difference value threshold may be preset. For example, it is assumed that the first difference value threshold<the second difference value threshold<the third difference value threshold. In response to the difference value between the predicted beam quality and the measured beam quality being within range 1, it may be considered that the accuracy of the beam quality information is relatively high; in response to the difference value between the predicted beam quality and the measured beam quality being within range 2, it may be considered that the accuracy of the beam quality information is acceptable and within a moderate range; in response to the difference value between the predicted beam quality and the measured beam quality being within range 3, it may be considered that the accuracy of the beam quality information is not high. Of course, each range may also be selected to correspond to a different interval according to actual conditions. For example, range 1 may refer to the difference value≤A1 dB, A1 dB<the difference value<A2 dB, or the difference value≥A2 dB; range 2 may refer to the difference value≤B1 dB, B1 dB<the difference value<B2 dB, or the difference value≥B2 dB; range 3 may refer to the difference value≤C1 dB, C1 dB<the difference value<C2 dB, or the difference value≥C2 dB.

Of course, the above is only an exemplary description. The present disclosure does not limit the magnitude relationship among the first difference value threshold, the second difference value threshold and the third difference value threshold, nor does it limit the specific range corresponding to each specified beam quality feature, and even less does it limit the accuracy rate of the beam quality information corresponding to each specified beam quality feature.

In some embodiments, the beam quality characteristic may include an average of the difference values between the predicted beam qualities and the measured beam qualities.

For example, the beam quality feature 1 may indicate that the average of the difference values between the predicted beam qualities and the measured beam qualities is within range 4. Range 4 may be less than or equal to A3 dB, for example, the average of the difference values between the predicted beam qualities and the measured beam qualities is less than or equal to A3 dB. Alternatively, range 4 may also be between A3 dB and A4 dB, for example, the average of the difference values between the predicted beam qualities and the measured beam qualities is within (A3 dB, A4 dB). Alternatively, range 4 may also be greater than or equal to A4 dB, for example, the average of the difference values between the predicted beam qualities and the measured beam qualities is greater than or equal to A4 dB. A4 is greater than A3.

For another example, beam quality feature 2 may indicate that the average of the difference values between the predicted beam qualities and the measured beam qualities is within range 5. Range 5 may be less than or equal to B3 dB, for example, the average of the difference values between the predicted beam qualities and the measured beam qualities is less than or equal to B3 dB. Alternatively, range 5 may also be between B3 dB and B4 dB, for example, the average of difference values between the predicted beam qualities and the measured beam qualities is within the range of (B3 dB, B4 dB). Alternatively, range 5 may also be greater than or equal to B4 dB, for example, the average of the difference values between the predicted beam qualities and the measured beam qualities is greater than or equal to B4 dB. B4 is greater than B3.

For another example, beam quality feature 3 may indicate that the average of the difference values between the predicted beam qualities and the measured beam qualities is within range 6. Range 6 may be less than or equal to C3 dB, for example, the average of the difference values between the predicted beam qualities and the measured beam qualities is less than or equal to C3 dB. Alternatively, range 6 may also be between C3 dB and C4 dB, for example, the average of the difference values between the predicted beam qualities and the measured beam qualities is within the range of (C3 dB, C4 dB). Alternatively, range 6 may also be greater than or equal to C4 dB, for example, the average of the difference values between the predicted beam qualities and the measured beam qualities is greater than or equal to C4 dB. C4 is greater than C3.

It can be understood that A3 dB and A4 dB may be referred to as the first average threshold, B3 dB and B4 dB may be referred to as the second average threshold, C3 dB and C4 dB may be referred to as the third average threshold. In some embodiments, the magnitude relationship among the first average threshold, the second average threshold, and the third average threshold may be preset. For example, it is assumed that the first average threshold<the second average threshold<the third average threshold. In response to the average of the difference values between the predicted beam qualities and the measured beam qualities being within range 4, it may be considered that the accuracy of the beam quality information is relatively high; in response to the average of the difference values between the predicted beam qualities and the measured beam qualities being within range 5, it may be considered that the accuracy of the beam quality information is acceptable and within a moderate range; in response to the average of the difference values between the predicted beam qualities and the measured beam qualities being within range 6, it may be considered that the accuracy of the beam quality information is not high. Of course, each range may also be selected to correspond to a different interval according to actual conditions. For example, range 4 may refer to the average of difference values≤A3 dB, A3 dB<the average of difference values<A4 dB, or the average of difference values≥A4 dB; range 5 may refer to the average of difference values≤B3 dB, B3 dB<the average of difference values<B4 dB, or the average of difference values≥B4 dB; range 6 may refer to the average of difference values≤C3 dB, C3 dB<the average of difference values<C4 dB, or the average of difference values≥C4 dB.

Of course, the above is only an exemplary description. The present disclosure does not limit the magnitude relationship among the first average threshold, the second average threshold and the third average threshold, nor does it limit the specific range corresponding to each specified beam quality feature, and even less does it limit the accuracy rate of the beam quality information corresponding to each specified beam quality feature.

In some embodiments, the beam quality feature may include a variance of the difference values between the predicted beam qualities and the measured beam qualities.

For example, the beam quality feature 1 may indicate that the variance of the difference values between the predicted beam qualities and the measured beam qualities is within range 7. Range 7 may be less than or equal to A5 dB, for example, the variance of the difference values between the predicted beam qualities and the measured beam qualities is less than or equal to A5 dB. Alternatively, range 7 may also be between A5 dB and A6 dB, for example, the variance of the difference values between the predicted beam qualities and the measured beam qualities is within (A5 dB, A6 dB). Alternatively, range 7 may also be greater than or equal to A5 dB, for example, the variance of the difference values between the predicted beam qualities and the measured beam qualities is greater than or equal to A6 dB. A6 is greater than A5.

For another example, beam quality feature 2 may indicate that the variance of the difference values between the predicted beam qualities and the measured beam qualities is within range 8. Range 8 may be less than or equal to B5 dB, for example, the variance of the difference values between the predicted beam qualities and the measured beam qualities is less than or equal to B5 dB. Alternatively, range 8 may also be between B5 dB and B6 dB, for example, the variance of difference values between the predicted beam qualities and the measured beam qualities is within the range of (B5 dB, B6 dB). Alternatively, range 8 may also be greater than or equal to B6 dB, for example, the variance of the difference values between the predicted beam qualities and the measured beam qualities is greater than or equal to B6 dB. B6 is greater than B5.

For another example, beam quality feature 3 may indicate that the variance of the difference values between the predicted beam qualities and the measured beam qualities is within range 9. Range 9 may be less than or equal to C5 dB, for example, the variance of the difference values between the predicted beam qualities and the measured beam qualities is less than or equal to C5 dB. Alternatively, range 9 may also be between C5 dB and C6 dB, for example, the variance of the difference values between the predicted beam qualities and the measured beam qualities is within the range of (C5 dB, C6 dB). Alternatively, range 9 may also be greater than or equal to C6 dB, for example, the variance of the difference values between the predicted beam qualities and the measured beam qualities is greater than or equal to C6 dB. C6 is greater than C5.

It can be understood that A5 dB and A6 dB may be referred to as the first variance threshold, B5 dB and B6 dB may be referred to as the second variance threshold, C5 dB and C6 dB may be referred to as the third variance threshold. In some embodiments, the magnitude relationship among the first variance threshold, the second variance threshold, and the third variance threshold may be preset. For example, it is assumed that the first variance threshold<the second variance threshold<the third variance threshold. In response to the variance of the difference values between the predicted beam qualities and the measured beam qualities being within range 7, it may be considered that the accuracy of the beam quality information is relatively high; in response to the variance of the difference values between the predicted beam qualities and the measured beam qualities being within range 8, it may be considered that the accuracy of the beam quality information is acceptable and within a moderate range; in response to the variance of the difference values between the predicted beam qualities and the measured beam qualities being within range 9, it may be considered that the accuracy of the beam quality information is not high. Of course, each range may also be selected to correspond to a different interval according to actual conditions. For example, range 7 may refer to the variance of difference values≤A5 dB, A5 dB<the variance of difference values<A6 dB, or the variance of difference values≥A6 dB; range 8 may refer to the variance of difference values≤B5 dB, B5 dB<the variance of difference values<B6 dB, or the variance of difference values≥B6 dB; range 9 may refer to the variance of difference values≤C5 dB, C5 dB<the variance of difference values<C6 dB, or the variance of difference values≥C6 dB.

Of course, the above is only an exemplary description. The present disclosure does not limit the magnitude relationship among the first variance threshold, the second variance threshold and the third variance threshold, nor does it limit the specific range corresponding to each specified beam quality feature, and even less does it limit the accuracy rate of the beam quality information corresponding to each specified beam quality feature.

In some embodiments, the measured beam quality may be obtained by actual measurement by the terminal. For example, the terminal calculates the difference value, the average of the difference values and/or the variance of the difference values based on the beam qualities measured for the beams in set B and the beam qualities predicted by the beam prediction model corresponding to the beams in set B, so as to obtain the specified beam quality feature.

In some embodiments, in response to the case that the beam prediction model is a spatial prediction, the relationship between set B and set A may be that set B is a wide beam and set A is a narrow beam. Regarding the measured beam quality, it can be obtained by the terminal based on historical experience. For example, none of the beam qualities of the beams in set A predicted by the terminal is actually measured.

In some embodiments, with respect to the measured beam quality, in response to the case that the beam prediction model is a time domain prediction, the beam prediction model uses the beam quality at the historical time to predict the beam quality at the future time. It can be understood that the beam qualities corresponding to the future time of the beams are all predicted by the beam prediction model, and there is no beam quality actually measured by the terminal. This is because the terminal at the current moment is unable to measure the beams at the future time.

The present disclosure provides a variety of different forms of beam quality features to indicate the degree of accuracy of beam quality information. By sending beam accuracy information to a network device, it can indicate whether the beam quality of the corresponding beam is accurate, thereby improving the accuracy of the beam prediction model for beam prediction.

In the communication method provided by the embodiments of the present disclosure, the beam accuracy information is further used to indicate at least one of the following: indicating the degree of accuracy of the beam quality information corresponding to any one beam in a beam set, where the beam in the beam set is a beam included in the beam report information; indicating the degree of accuracy of the beam quality information corresponding to any multiple beams in the beam set; indicating the degree of accuracy of the beam quality information corresponding to all beams in the beam set; and indicating the degree of accuracy of the beam quality information corresponding to a beam in any one or more beam subsets, where one beam subset corresponds to at least one beam at one time point.

In some embodiments, the beam accuracy information is further used to indicate the degree of accuracy of beam quality information corresponding to any beam in the beam set, where the beam in the beam set is the beam included in the beam report information.

For example, the beam accuracy information in the beam report information may indicate, for any one of the beams included in the beam report information, the degree of accuracy of the beam quality information corresponding to that beam. Of course, it may also be considered that the beam accuracy information may independently indicate, for each beam in the beam report information, the degree of accuracy of the beam quality information corresponding to that beam.

In some embodiments, the beam accuracy information is further used to indicate the degree of accuracy of beam quality information corresponding to any number of beams in the beam set.

For example, the beam accuracy information in the beam report information may indicate, for any multiple beams included in the beam report information, the degree of accuracy of the beam quality information corresponding to these multiple beams. Of course, it may also be considered that the beam accuracy information may collectively indicate, for any multiple beams in the beam report information, the degree of accuracy of the beam quality information corresponding to these beams.

In some embodiments, the beam accuracy information is further used to indicate the degree of accuracy of the beam quality information corresponding to all beams in the beam set.

For example, the beam accuracy information in the beam report information may indicate, for all beams included in the beam report information, the degree of accuracy of the beam quality information corresponding to all beams. Of course, it may also be considered that the beam accuracy information may collectively indicate, for all beams in the beam report information, the degree of accuracy of the beam quality information corresponding to all beams.

In some embodiments, the beam accuracy information is further used to indicate the degree of accuracy of beam quality information corresponding to a beam in any one or more beam subsets, where one beam subset corresponds to at least one beam at one time point.

For example, the beam accuracy information in the beam report information may indicate, for the beam in any one or more beam subsets, the degree of accuracy of the beam quality information corresponding to any one or more beam subsets. One beam subset corresponds to at least one beam at one time point. That is, the beam accuracy information may perform indication for the beam quality information at one or more time points among the beam quality information at multiple time points contained in one beam report.

For example, when one beam report includes beam quality information at multiple time points, the beam quality information for each time point may be regarded as a beam subset, and one piece of beam accuracy information is indicated for each beam subset. This is more applicable to the beam report information where the beam prediction model is a time-domain prediction model. In this case, the beam information predicted by the beam prediction model may include beam measurement information at multiple time points. In the beam measurement information at each time point, the beam measurement information at some time points may be obtained by the terminal through measurement, and the beam measurement information at some other time points may be obtained by the terminal through prediction by using the beam prediction model.

The present disclosure provides a variety of different manners for indicating beam accuracy information to indicate the degree of accuracy of the beam quality information. By sending beam accuracy information to the network device, it can indicate whether the beam quality of the corresponding beam is accurate, thereby improving the accuracy of the beam prediction model for beam prediction.

In the communication method provided by the embodiments of the present disclosure, the beam quality information may include at least one piece of the following information: a layer 1 reference signal received power (L1-RSRP); and a layer 1 signal to interference plus noise ratio (L1-SINR).

In some embodiments, the beam quality information may include L1-RSRP.

In some embodiments, the beam quality information may include L1-SINR.

The present disclosure provides a variety of different beam quality information. By sending beam accuracy information to the network device, it can indicate whether the beam quality of the corresponding beam is accurate, thereby improving the accuracy of the beam prediction model for beam prediction.

In the communication method provided by the embodiments of the present disclosure, the beam report information further includes: a beam identifier, where the beam identifier includes a transmitting beam identifier and/or a receiving beam identifier.

In some embodiments, the beam report information may further include a beam identifier, which may be, for example, an ID or an index.

In some embodiments, the beam identifier may include a transmitting beam identifier. For example, the transmitting beam identifier may be a Tx beam ID.

In some embodiments, the beam identifier may include a receiving beam identifier. For example, the receiving beam identifier may be an Rx beam ID.

The present disclosure provides that beam report information may further include a beam identifier. By sending beam accuracy information to the network device, it can indicate whether the beam quality of the beam corresponding to the beam identifier is accurate, thereby improving the accuracy of the beam prediction model for beam prediction.

In the communication method provided by the embodiments of the present disclosure, the transmitting beam identifier is a synchronization signal block (SSB) identifier or a channel state information reference signal (CSI-RS) identifier.

In some embodiments, the transmitting beam identifier may be an SSB identifier. For example, the Tx beam ID may be an SSB index.

In some embodiments, the transmitting beam ID may be a channel state information reference signal (CSI-RS) identifier. For example, the Tx beam ID may be a CSI-RS index.

The present disclosure provides a variety of different transmitting beam identifiers. By sending beam accuracy information to a network device, it can indicate whether the beam quality of the transmitting beam corresponding to the transmitting beam identifier is accurate, thereby improving the accuracy of the beam prediction model for beam prediction.

In the communication method provided by the embodiments of the present disclosure, the beam report information includes at least one set of beams, where beams in a same set are beams that the terminal supports to receive simultaneously; or, beams in a same set are beams that the terminal supports to transmit simultaneously; or, beams in a same set are beams that the terminal does not support to receive simultaneously; or, beams in a same set are beams that the terminal does not support to transmit simultaneously.

In some embodiments, the beam report information may include at least one set of beams, where the beams in the same set are beams that the terminal supports or does not support for simultaneous reception or simultaneous transmission.

In some embodiments, beams in the same set are beams that the terminal supports to receive simultaneously.

In some embodiments, beams in the same set are beams that the terminal supports to transmit simultaneously.

It can be understood that the beams in the same set are beams that the terminal supports for simultaneous reception and/or simultaneous transmission, which may correspond to the group based beam reporting attribute. Alternatively, the group based beam reporting attribute is enabled. This attribute indicates that the beams corresponding to multiple reference signal (RS) IDs within one group may be simultaneously received and/or simultaneously transmitted by the terminal. Of course, this attribute may also indicate that the beams corresponding to two RS IDs from different groups may be simultaneously received and/or simultaneously transmitted by the terminal.

In some embodiments, beams in the same set are beams that the terminal does not support to receive simultaneously.

In some embodiments, beams in the same set are beams that the terminal does not support to transmit simultaneously.

For example, the beams in the same set are beams that the terminal does not support for simultaneous reception and/or simultaneous transmission, which may correspond to the non-group based beam reporting attribute. Alternatively, the group based beam reporting attribute is disabled.

The present disclosure can be applied to terminals with various attributes. By sending beam accuracy information to the network device, it can indicate whether the beam quality of the transmitting beam corresponding to the transmitting beam identifier is accurate, thereby improving the accuracy of the beam prediction model for beam prediction.

It should be noted that those skilled in the art can understand that various implementation manners/embodiments involved in the embodiments of the disclosure can be used in combination with the foregoing embodiments, or can be used independently. Whether it is used independently or in combination with the foregoing embodiments, the implementation principles thereof are similar. During implementation of the disclosure, some embodiments are described in an implementation manner of being used together. Certainly, those skilled in the art can understand that such illustrations are not intended to limit embodiments of the disclosure.

On the basis of the same concept, the embodiments of the present disclosure further provide a communication apparatus and device.

It can be understood that in order to implement the above functions, the communication apparatus and device provided in the embodiments of the disclosure include corresponding hardware structures and/or software modules for executing various functions. With reference to the units and algorithm steps of the examples disclosed in the embodiments of the present disclosure, the embodiments of the present disclosure can be implemented in the form of hardware or a combination of hardware and computer software. Whether a certain function is executed in the form of hardware or in the way that computer software drives the hardware depends on the specific application and design constraints of the technical solution. Those skilled in the art can implement the described functions through different methods for each particular application, but such implementation should not be considered beyond the scope of the technical solutions of the embodiments of the disclosure.

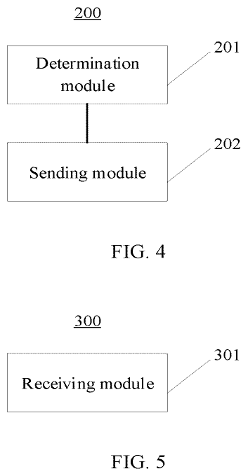

FIG. 4 is a schematic diagram of a communication apparatus shown according to an exemplary embodiment. Referring to FIG. 4, the apparatus 200 is configured in a terminal, and includes: a determination module 201, configured to determine beam report information, where the beam report information includes beam quality information and beam accuracy information, and the beam accuracy information is used to indicate a degree of accuracy of the beam quality information; and a sending module 202, configured to send the beam report information to a network device.

The present disclosure carries beam accuracy information in the beam report information sent to the network device, which can indicate whether the beam quality of the corresponding beam is accurate, thereby improving the accuracy of the beam prediction model for the beam prediction.

In an implementation manner, the beam accuracy information indicating the degree of accuracy of the beam quality information includes: indicating that the beam quality information is inaccurate, or indicating at least one of the following degrees of accuracy of the beam quality information: indicating that the beam quality information is accurate; indicating the beam quality information as an accuracy rate predicted by the terminal through a beam prediction model; and indicating the beam quality information as a specified beam quality feature, where the beam quality feature represents a difference between a predicted beam quality and a measured beam quality.

The present disclosure provides various forms of beam accuracy information to indicate the degree of accuracy of the beam quality information. By sending the beam accuracy information to the network device, it can indicate whether the beam quality of the corresponding beam is accurate, thereby improving the accuracy of the beam prediction model for beam prediction.

In an implementation manner, the beam quality feature includes any one of the following: a difference value between the predicted beam quality and the measured beam quality; an average of difference values between predicted beam qualities and measured beam qualities; and a variance of difference values between predicted beam qualities and measured beam qualities.

The present disclosure provides a variety of different forms of beam quality features to indicate the degree of accuracy of beam quality information. By sending beam accuracy information to the network device, it can indicate whether the beam quality of the corresponding beam is accurate, thereby improving the accuracy of the beam prediction model for beam prediction.

In an implementation manner, the beam accuracy information is further used to indicate at least one of the following: indicating the degree of accuracy of the beam quality information corresponding to any one beam in a beam set, where the beam in the beam set is a beam included in the beam report information; indicating the degree of accuracy of the beam quality information corresponding to any number of beams in the beam set; indicating the degree of accuracy of the beam quality information corresponding to all beams in the beam set; and indicating the degree of accuracy of the beam quality information corresponding to a beam in any one or more beam subsets, where one beam subset corresponds to at least one beam at one time point.

The present disclosure provides a variety of different manners for indicating beam accuracy information to indicate the degree of accuracy of the beam quality information. By sending beam accuracy information to the network device, it can indicate whether the beam quality of the corresponding beam is accurate, thereby improving the accuracy of the beam prediction model for beam prediction.

In an implementation manner, the beam quality information includes at least one piece of the following information: a layer 1 reference signal received power (L1-RSRP); and a layer 1 signal to interference plus noise ratio (L1-SINR).

The present disclosure provides a variety of different beam quality information. By sending beam accuracy information to the network device, it can indicate whether the beam quality of the corresponding beam is accurate, thereby improving the accuracy of the beam prediction model for beam prediction.

In an implementation manner, the beam report information further includes: a beam identifier, where the beam identifier includes a transmitting beam identifier and/or a receiving beam identifier.

The present disclosure provides that beam report information may further include a beam identifier. By sending beam accuracy information to the network device, it can indicate whether the beam quality of the beam corresponding to the beam identifier is accurate, thereby improving the accuracy of the beam prediction model for beam prediction.

In an implementation manner, the transmitting beam identifier is a synchronization signal block (SSB) identifier or a channel state information reference signal (CSI-RS) identifier.

The present disclosure provides a variety of different transmitting beam identifiers. By sending beam accuracy information to a network device, it can indicate whether the beam quality of the transmitting beam corresponding to the transmitting beam identifier is accurate, thereby improving the accuracy of the beam prediction model for beam prediction.

In an implementation manner, the beam report information includes at least one set of beams, where beams in a same set are beams that the terminal supports to receive simultaneously; or, beams in a same set are beams that the terminal supports to transmit simultaneously; or, beams in a same set are beams that the terminal does not support to receive simultaneously; or, beams in a same set are beams that the terminal does not support to transmit simultaneously.

The present disclosure can be applied to terminals with various attributes. By sending beam accuracy information to the network device, it can indicate whether the beam quality of the transmitting beam corresponding to the transmitting beam identifier is accurate, thereby improving the accuracy of the beam prediction model for beam prediction.

FIG. 5 is a schematic diagram of another communication apparatus shown according to an exemplary embodiment. Referring to FIG. 5, the apparatus 300 is configured in a network device, and includes: a receiving module 301, configured to receive beam report information sent by a terminal, where the beam report information includes beam quality information and beam accuracy information, and the beam accuracy information is used to indicate a degree of accuracy of the beam quality information.

The present disclosure carries beam accuracy information in the beam report information sent to the network device, which can indicate whether the beam quality of the corresponding beam is accurate, thereby improving the accuracy of the beam prediction model for the beam prediction.

In an implementation manner, the beam accuracy information indicating the degree of accuracy of the beam quality information includes: indicating that the beam quality information is inaccurate, or indicating at least one of the following degrees of accuracy of the beam quality information: indicating that the beam quality information is accurate; indicating the beam quality information as an accuracy rate predicted by the terminal through a beam prediction model; and indicating the beam quality information as a specified beam quality feature, where the beam quality feature represents a difference between a predicted beam quality and a measured beam quality.

The present disclosure provides various forms of beam accuracy information to indicate the degree of accuracy of the beam quality information. By sending the beam accuracy information to the network device, it can indicate whether the beam quality of the corresponding beam is accurate, thereby improving the accuracy of the beam prediction model for beam prediction.

In an implementation manner, the beam quality feature includes any one of the following: a difference value between the predicted beam quality and the measured beam quality; an average of difference values between predicted beam qualities and measured beam qualities; and a variance of difference values between predicted beam qualities and measured beam qualities.

The present disclosure provides a variety of different forms of beam quality features to indicate the degree of accuracy of beam quality information. By sending beam accuracy information to the network device, it can indicate whether the beam quality of the corresponding beam is accurate, thereby improving the accuracy of the beam prediction model for beam prediction.

In an implementation manner, the beam accuracy information is further used to indicate at least one of the following: indicating the degree of accuracy of the beam quality information corresponding to any one beam in a beam set, where the beam in the beam set is a beam included in the beam report information; indicating the degree of accuracy of the beam quality information corresponding to any number of beams in the beam set; indicating the degree of accuracy of the beam quality information corresponding to all beams in the beam set; and indicating the degree of accuracy of the beam quality information corresponding to beams in any one or more beam subsets, where one beam subset corresponds to at least one beam at one time point.

The present disclosure provides a variety of different manners for indicating beam accuracy information to indicate the degree of accuracy of the beam quality information. By sending beam accuracy information to the network device, it can indicate whether the beam quality of the corresponding beam is accurate, thereby improving the accuracy of the beam prediction model for beam prediction.

In an implementation manner, the beam quality information includes at least one piece of the following information: a layer 1 reference signal received power (L1-RSRP); and a layer 1 signal to interference plus noise ratio (L1-SINR).

The present disclosure provides a variety of different beam quality information. By sending beam accuracy information to the network device, it can indicate whether the beam quality of the corresponding beam is accurate, thereby improving the accuracy of the beam prediction model for beam prediction.

In an implementation manner, the beam report information further includes: a beam identifier, where the beam identifier includes a transmitting beam identifier and/or a receiving beam identifier.

The present disclosure provides that beam report information may further include a beam identifier. By sending beam accuracy information to the network device, it can indicate whether the beam quality of the beam corresponding to the beam identifier is accurate, thereby improving the accuracy of the beam prediction model for beam prediction.

In an implementation manner, the transmitting beam identifier is a synchronization signal block (SSB) identifier or a channel state information reference signal (CSI-RS) identifier.

The present disclosure provides a variety of different transmitting beam identifiers. By sending beam accuracy information to a network device, it can indicate whether the beam quality of the transmitting beam corresponding to the transmitting beam identifier is accurate, thereby improving the accuracy of the beam prediction model for beam prediction.

In an implementation manner, the beam report information includes at least one set of beams, where beams in a same set are beams that the terminal supports to receive simultaneously; or, beams in a same set are beams that the terminal supports to transmit simultaneously; or, beams in a same set are beams that the terminal does not support to receive simultaneously; or, beams in a same set are beams that the terminal does not support to transmit simultaneously.

The present disclosure can be applied to terminals with various attributes. By sending beam accuracy information to the network device, it can indicate whether the beam quality of the transmitting beam corresponding to the transmitting beam identifier is accurate, thereby improving the accuracy of the beam prediction model for beam prediction.

It should be noted that the various modules/units involved in the communication apparatus 200 and the communication apparatus 300 involved in the embodiments of the present disclosure are only exemplary and are not intended to be limiting. For example, the communication apparatus 200 in the embodiments of the present disclosure may further include a receiving module and/or a processing module. The communication apparatus 300 may further include a sending module and/or a processing module. The various modules included in the communication apparatus 200 and the communication apparatus 300 may interact with each other and may also interact with other network element devices.

Regarding the apparatus in the above embodiments, the specific manners in which each module performs operations have been described in detail in the embodiments related to the method, and will not be elaborated herein.

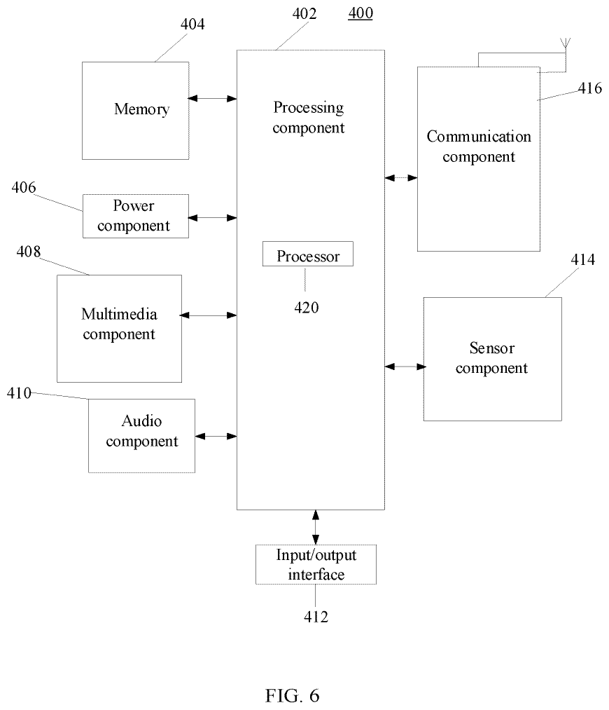

FIG. 6 is a schematic diagram of a communication device shown according to an exemplary embodiment. For example, the device 400 may be a mobile phone, a computer, a digital broadcasting terminal, a message receiving and transmitting device, a game console, a tablet device, a medical device, a fitness device, a personal digital assistant, etc.

Referring to FIG. 6, the device 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operation of the device 400, such as the operations associated with display, telephone calls, data communications, camera operations, and recording operations. The processing component 402 may include one or more processors 420 to execute instructions to complete all or part of the steps of the above described methods. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, videos, etc. The memory 404 may be implemented using any type of volatile or non-volatile memory devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the device 400. The power component 406 may include a power management system, one or more power sources, and any other components associated with the generation, management, and distribution of power in the apparatus 400.

The multimedia component 408 includes a screen providing an output interface between the device 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 408 includes a front camera and/or a rear camera. The front camera and/or the rear camera may receive external multimedia data while the device 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 includes a microphone (MIC) configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide status assessments of various aspects of the device 400. For instance, the sensor component 414 may detect an open/closed status of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an acceleration sensor, a gyroscope sensor, a magnetic sensor, a pressure sensor, or a temperature sensor.

The communication component 416 is configured to facilitate communication, wired or wirelessly, between the device 400 and other devices. The device 400 can access a wireless network based on a communication standard, such as WiFi, 2G or 3G, or a combination thereof. In an exemplary embodiment, the communication component 416 receives a broadcast signal or broadcast associated information from an external broadcast management system via a broadcast channel. In an exemplary embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 404, executable by the processor 420 in the device 400, for completing the above methods. For example, the non-transitory computer-readable storage medium may be a ROM, a random access memory (RAM), a CD-ROM, a magnetic tape, a floppy disc, an optical data storage device, and the like.

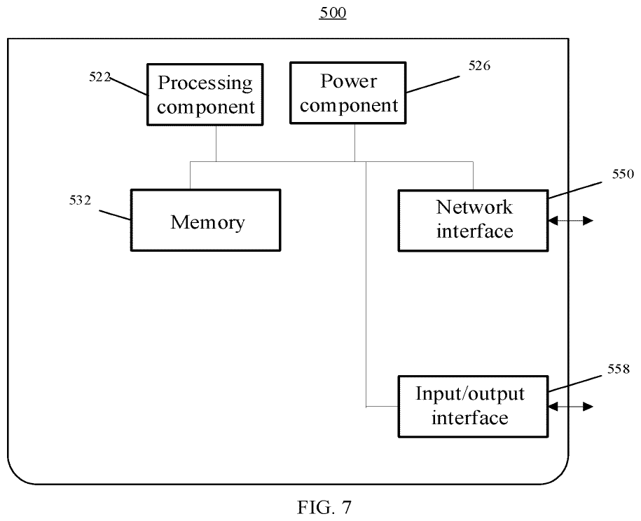

FIG. 7 is a schematic diagram of another communication device shown according to an exemplary embodiment. For example, device 500 may be provided as a base station, or a server. Referring to FIG. 7, the device 500 includes a processing component 522, which further includes one or more processors, and a memory resource represented by a memory 532 for storing instructions, such as an application program, that may be executed by the processing component 522. The application program stored in the memory 532 may include one or more modules, each corresponding to a set of instructions. In addition, the processing component 522 is configured to execute instructions to perform any of the aforementioned methods.

The device 500 may further include a power component 526 configured to perform power management of the device 500, a wired or wireless network interface 550 configured to connect the device 500 to a network, and an input/output (I/O) interface 558. The device 500 may operate based on an operating system stored in the memory 532, such as a Windows Server™, a Mac OS X™, a Unix™, a Linux™, a FreeBSD™, or the like.

The present disclosure carries beam accuracy information in the beam report information sent to the network device, which can indicate whether the beam quality of the corresponding beam is accurate, thereby improving the accuracy of the beam prediction model for the beam prediction.

The technical solutions provided by the embodiments of the present disclosure may include the following beneficial effects: by carrying beam accuracy information in the beam report information sent to the network device, it can indicate whether the beam quality of the corresponding beam is accurate, thereby improving the accuracy of the beam prediction model for beam prediction.

It may be further understood that, in the present disclosure, “a plurality of” means two or more than two, and other quantifiers are similar thereto. “And/or” describes the association relationship of associated objects, which indicates that three relationships may exist. For example, A and/or B may represent: A exists alone, A and B exist at the same time, and B exists alone. The character “/” generally indicates that the associated objects before and after are in an “or” relationship. The singular forms of “a”, “the” and “said” are also intended to include the plural forms, unless otherwise clearly indicated by the context.

It may be further understood that the terms “first”, “second”, etc. are used to describe various information, but such information should not be limited to these terms. These terms are only used to distinguish information of the same type from each other, and do not indicate a specific order or degree of importance. In fact, the expressions “first”, “second”, etc. can be used interchangeably. For example, without departing from the scope of the present disclosure, the first information can also be referred to as the second information, and similarly, the second information can also be referred to as the first information.

It can be further understood that the meanings of the terms such as “in response to” and “if” involved in the present disclosure depend on the context and the actual usage scenarios. For example, the term “in response to” used herein may be interpreted as “at the time of” or “when . . . ” or “if” or “upon”.

It can be further understood that, although the operations are described in a specific order in the drawings in the embodiments of the present disclosure, it should not be construed as requiring the operations to be performed in the specific order shown or in a sequential order, nor as requiring the execution of all the operations shown to obtain the desired result. In certain environments, multitasking and parallel processing may be advantageous.

Those skilled in the art will readily appreciate other implementation solutions of the present disclosure after considering the specification and practicing the disclosure disclosed herein. The present disclosure is intended to cover any variations, uses or adaptations of the present disclosure that follow the general principles of the present disclosure and include common knowledge or customary technical means in the art that are not disclosed in the present disclosure.

It should be understood that the present disclosure is not limited to the exact structures that have been described above and shown in the accompanying drawings, and various modifications and changes may be made without departing from the scope thereof. The scope of the present disclosure is limited only by the appended claims.

1. A communication method, wherein the method is performed by a terminal, and comprises:
determining beam report information, wherein the beam report information comprises beam quality information and beam accuracy information, and the beam accuracy information is used for indicating a degree of accuracy of the beam quality information; and
sending the beam report information to a network device.

2. The method according to claim 1, wherein the beam accuracy information being used for indicating the degree of accuracy of the beam quality information, comprises:
indicating that the beam quality information is inaccurate, or indicating at least one of following degrees of accuracy of the beam quality information:
indicating that the beam quality information is accurate;
indicating that the beam quality information is an accuracy rate predicted by the terminal through a beam prediction model; or
indicating that the beam quality information is a specified beam quality feature, wherein the beam quality feature represents a difference between a predicted beam quality and a measured beam quality.

3. The method according to claim 2, wherein the beam quality feature comprises any one of following:
a difference value between the predicted beam quality and the measured beam quality;
an average of difference values between predicted beam qualities and measured beam qualities; and
a variance of the difference values between the predicted beam qualities and the measured beam qualities.

4. The method according to claim 1, wherein the beam accuracy information is further used for indicating at least one of following:
indicating the degree of accuracy of the beam quality information corresponding to any one beam in a beam set, wherein the beam in the beam set is a beam comprised in the beam report information;
indicating the degree of accuracy of the beam quality information corresponding to any number of beams in the beam set;
indicating the degree of accuracy of the beam quality information corresponding to all beams in the beam set; or
indicating the degree of accuracy of the beam quality information corresponding to a beam in any one or more beam subsets, wherein one beam subset corresponds to at least one beam at one time point.

5. The method according to claim 1, wherein the beam quality information comprises at least one piece of following information:
a layer 1 reference signal received power (L1-RSRP); or
a layer 1 signal to interference plus noise ratio (L1-SINR).

6. The method according to claim 1, wherein the beam report information further comprises: a beam identifier, and the beam identifier comprises at least one of a transmitting beam identifier or a receiving beam identifier.

7. The method according to claim 6, wherein the transmitting beam identifier is a synchronization signal block (SSB) identifier or a channel state information reference signal (CSI-RS) identifier.

8. The method according to claim 1,
wherein the beam report information comprises at least one set of beams, wherein, beams in a same set are beams that the terminal supports to receive simultaneously; or
beams in a same set are beams that the terminal supports to transmit simultaneously; or
beams in a same set are beams that the terminal does not support to receive simultaneously; or
beams in a same set are beams that the terminal does not support to transmit simultaneously.

9. A communication method, wherein the method is performed by a network device, and comprises:
receiving beam report information sent by a terminal;
wherein the beam report information comprises beam quality information and beam accuracy information, and the beam accuracy information is used for indicating a degree of accuracy of the beam quality information.

10. The method according to claim 9, wherein the beam accuracy information being used for indicating the degree of accuracy of the beam quality information, comprises:
indicating that the beam quality information is inaccurate, or indicating at least one of following degrees of accuracy of the beam quality information:
indicating that the beam quality information is accurate;
indicating that the beam quality information is an accuracy rate predicted by the terminal through a beam prediction model; or
indicating that the beam quality information is a specified beam quality feature, wherein the beam quality feature represents a difference between a predicted beam quality and a measured beam quality.

11. The method according to claim 10, wherein the beam quality feature comprises any one of following:
a difference value between the predicted beam quality and the measured beam quality; an average of difference values between predicted beam qualities and measured beam qualities; and
a variance of the difference values between the predicted beam qualities and the measured beam qualities.

12. The method according to claim 9, wherein the beam accuracy information is further used for indicating at least one of following:
indicating the degree of accuracy of the beam quality information corresponding to any one beam in a beam set, wherein the beam in the beam set is a beam comprised in the beam report information;
indicating the degree of accuracy of the beam quality information corresponding to any number of beams in the beam set;
indicating the degree of accuracy of the beam quality information corresponding to all beams in the beam set; or
indicating the degree of accuracy of the beam quality information corresponding to a beam in any one or more beam subsets, wherein one beam subset corresponds to at least one beam at one time point.

13. The method according to claim 9, wherein the beam quality information comprises at least one piece of following information:
a layer 1 reference signal received power (L1-RSRP); or
a layer 1 signal to interference plus noise ratio (L1-SINR).

14. The method according to claim 9, wherein the beam report information further comprises: a beam identifier, and the beam identifier comprises at least one of a transmitting beam identifier or a receiving beam identifier.

15. The method according to claim 14, wherein the transmitting beam identifier is a synchronization signal block (SSB) identifier or a channel state information reference signal (CSI-RS) identifier.

16. The method according to claim 9, wherein the beam report information comprises at least one set of beams, wherein,
beams in a same set are beams that the terminal supports to receive simultaneously; or
beams in a same set are beams that the terminal supports to transmit simultaneously; or
beams in a same set are beams that the terminal does not support to receive simultaneously; or
beams in a same set are beams that the terminal does not support to transmit simultaneously.

17-18. (canceled)

19. A terminal, comprising:
a processor; and
a memory for storing processor-executable instructions;
wherein the processor is configured to:
determine beam report information, wherein the beam report information comprises beam quality information and beam accuracy information, and the beam accuracy information is used for indicating a degree of accuracy of the beam quality information; and
send the beam report information to a network device.

20. A network, comprising:
a processor; and
a memory for storing processor-executable instructions;
wherein the processor is configured to execute the method according to claim 9.

21. A non-transitory computer-readable storage medium, wherein
instructions in the storage medium, when being executed by a processor of a terminal, enable the terminal to perform the method according to claim 1.

22. A non-transitory computer-readable storage medium, wherein instructions in the storage medium, when being executed by a processor of a network device, enable the network device to perform the method according to claim 9.
